(19) United States
(12) Patent Application Publication
(10) Pub. No.: US 2018/0340240 A1
(43) Pub. Date: Nov. 29, 2018

(54) SYSTEM AND METHOD FOR BRIQUETTING CYCLONE DUST FROM DECOATING SYSTEMS

(71) Applicant: Novelis Inc., Atlanta, GA (US)

(72) Inventors: Don Doutre, Kingston (CA); Allan Sweeney, Quedlinburg (DE)

(73) Assignee: Novelis Inc., Atlanta, GA (US)

(21) Appl. No.: 15/989,992

(22) Filed: May 25, 2018

Related U.S. Application Data
(60) Provisional application No. 62/511,380, filed on May 26, 2017.

(51) Int. Cl. C22B 1/00; B01D 45/16

(52) U.S. Cl. CPC C22B 1/005; B01D 45/16

(57) ABSTRACT

A decoating system includes a dust cyclone and a dust briquetter. The dust cyclone is configured to receive an exhaust gas from a decoating kiln of the decoating system and remove organic particulate matter from the exhaust gas as dust. The dust briquetter is configured to receive the dust from the dust cyclone and compress the dust into dust briquettes.

### REFERENCE TO RELATED APPLICATIONS

This application claims the benefit of U.S. Provisional Application No. 62/511,380, filed on May 26, 2017 and entitled SYSTEM AND METHOD FOR BRIQUETTING CYCLONE DUST FROM DECOATING SYSTEMS, the disclosure of which are hereby incorporated by reference in its entirety.

### FIELD OF THE INVENTION

This application relates to metal recycling, and more particularly to decoating systems for metal recycling.

### BACKGROUND

During metal recycling, metal scrap (such as aluminum or aluminum alloys) are crushed, shredded, chopped, or otherwise reduced into smaller pieces of metal scrap. Oftentimes, the metal scrap has various coatings, such as oils, paints, lacquers, plastics, inks, and glues, as well as various other organic contaminants such as paper, plastic bags, polyethylene terephthalate (PET), sugar residues, etc., that must be removed through a decoating process before the metal scrap can be further processed and recovered.

During decoating with a decoating system, the organic compounds are vaporized and some of the organic compounds are filtered out, along with other finely divided materials (aluminum fines, clay, glass, various inorganic materials such as pigments, etc.), as dust through a dust cyclone of the decoating system. Because this dust contains a large proportion of organic compounds, the dust is susceptible to spontaneous combustion and the creation of dust fires when it is discharged from the decoating system. These fires are very difficult to extinguish, even with water or fire extinguishers. Moreover, if water were used to wet the dust to make a slurry mixture of the water and dust, the mixture may be costly to dispose of due to the content of the slurry mixture, the process may be costly to implement because of the quantity of water needed on a daily basis, and the mixture may present potential safety and environmental issues.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

In various examples, a decoating system includes a dust cyclone (or other suitable solid/gas separator) and a dust briquetter. The dust cyclone is configured to receive an exhaust gas from a decoating kiln of the decoating system and separate particulate matter (both organic and inorganic) from the exhaust gas as dust. The dust briquetter is configured to receive the dust from the dust cyclone and compress the dust into dust briquettes. In some examples, a method of forming dust briquettes from dust from a dust cyclone of a decoating system includes extracting the dust containing organic particulate matter from the dust cyclone of the decoating system, cooling the dust from a discharge temperature to a briquetting temperature, and compressing the dust with a dust briquetter to form dust briquettes. Optionally, in some examples, a binding agent is mixed with the dust to reduce the temperature of the dust to the briquetting temperature and/or to improve briquette formation. In some examples, aluminum or aluminum powders rich in magnesium, or various other metals as desired, can be recovered from the dust briquettes.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a schematic diagram depicting a decoating system according to aspects of the present disclosure.

FIG. 2 is a flowchart depicting an exemplary briquetting process for the decoating system of FIG. 1.

### DETAILED DESCRIPTION

The subject matter of examples of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

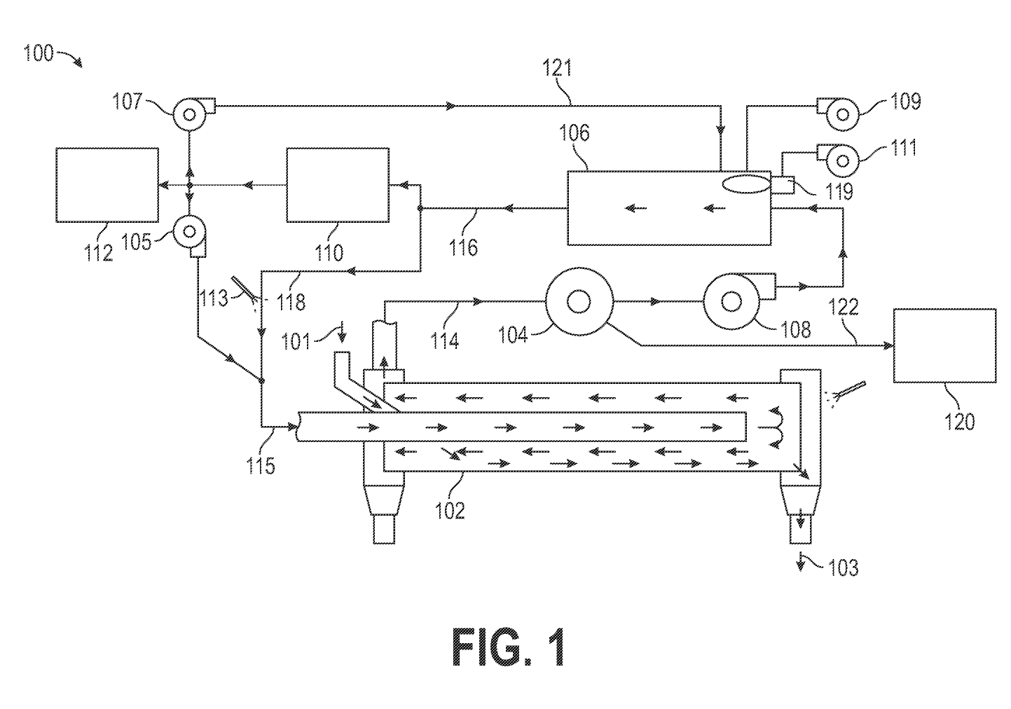

FIG. 1 illustrates a decoating system 100 for removing coatings and other organic contaminants from metal scrap, such as aluminum or aluminum alloys, according to aspects of the present disclosure. The decoating system 100 generally includes a kiln 102, a cyclone 104 (or other suitable solid/gas separator), and an afterburner 106. Other components such as a recirculation fan 108, a heat exchanger 110, and exhaust system 112 are also included as part of the decoating system 100. As illustrated in FIG. 1, the decoating system 100 further includes a dust briquetter 120.

During a decoating process with the decoating system 100, metal scrap 101 is fed into the kiln 102. Heated gas 115 is injected into the kiln 102 to raise the temperature within the kiln 102 and vaporize the organic matter without melting the scrap metal. In many cases, the oxygen concentration within the decoating system 100 is maintained at a low level (such as from about 6% to about 8% oxygen) such that the organic materials do not ignite. For example, within the decoating system, the atmosphere may be 7% oxygen such that the organic compounds do not ignite even though they are at elevated temperatures due to the decoating process. The decoated scrap metal 103 is removed from the kiln 102 for further processing and ultimately processing into new aluminum products.

Exhaust gas containing the vaporized organic compounds (sometimes referred to as “VOCs”) exits the kiln 102 through a duct 114, which connects the kiln 102 to the cyclone 104. Within the cyclone 104, larger organic compound particulates are removed from the exhaust gas as dust and ultimately discharged from the cyclone 104 for disposal. From the cyclone 104, the exhaust gas is directed into the afterburner 106. The afterburner 106 incinerates the remaining organic compounds within the exhaust gas, and discharges a heated gas into a duct 116 that leads to the exhaust system 112 (e.g., a baghouse) or the atmosphere, or that can be fed into the kiln 102. The afterburner 106 may include a hot air burner 119 or other suitable device for heating the gas. The temperature of the heated gas within the duct 116 is greater than the temperature of the exhaust gas from the kiln 102 within the duct 114. For example, in various cases, the temperature of the exhaust gas within the duct 114 is generally from about 250° C. to about 400° C., while the temperature of the heated gas within the duct 116 is generally from about 700° C. to about 900° C. In some examples, some of the heated gas exiting the afterburner 106 is optionally recirculated back to the kiln 102 through a recirculation duct 118. In various examples, cooling devices 113 (such as water sprayers) are provided to cool a temperature of the heated gas from the afterburner 106 before the gas is recirculated back to the kiln 102.

As illustrated in FIG. 1, in some examples, the exhaust gas exiting the afterburner 106 through the duct 116 is directed through the heat exchanger 110 that reduces a temperature of the exhaust gas. In various examples, some of the cooled exhaust air exiting the heat exchanger 110 may be recirculated through an air mover 105 back to the kiln 102. Alternatively or additionally, some of the cooled exhaust air exiting the heat exchanger 110 may be recirculated through an air mover 107 back to the afterburner 106 as cooling air 121 to aid in controlling the atmosphere within the afterburner 106. In various examples, additional air movers 109 and 111 are provided to supply oxygen (air mover 109) and combustion air (air mover 111) to control the atmosphere within the afterburner 106.

The dust discharged from the cyclone 104 is susceptible to combustion and the formation of fires because the dust exits the cyclone at a relatively high temperature. Because the dust particles are loosely packed, the rate of air ingress into a pile of dust is relatively high further promoting combustion. These dust fires are very difficult to extinguish, even with water or fire extinguishers. Moreover, if water were used to wet the dust to make a slurry mixture of the water and dust, the mixture may be costly to dispose of due to the nature of the components of the resulting slurry mixture as well as the increased mass of the material. The process further may be costly to implement because of the quantity of water needed on a daily basis, and the mixture may present potential safety and environmental issues.

A feed path 122 from the cyclone 104 to the dust briquetter 120 optionally includes a conveyor, passage or other similar mechanism suitable for delivering the dust from the cyclone 104 to the dust briquetter 120 after it is discharged from the cyclone 104. In other examples, the feed path 122 is a collector (such as a hopper or bin) that collects the dust from the cyclone 104 and delivers the dust to the dust briquetter 120 when enough dust has collected to form dust briquettes.

The dust briquetter 120 is configured to compress the dust into dust briquettes. In some examples, the dust briquetter 120 is configured to apply a force of about 1300 kg/cm² to about 2500 kg/cm² to compress the dust. The dust may be cooled during compression or before compression (within the dust briquetter 120 and/or before entry into the dust briquetter 120). Compressing and cooling the dust into briquettes minimizes oxygen contact with combustible organic compounds in the dust, and further reduces the temperature of the dust. In various cases, the dust briquettes formed by the dust briquetter may be used in various industries such as cement, steel, and refractories, among others. Aluminum can also be recovered from the dust briquettes and reused in other processes.

In various examples, the dust briquetter 120 includes features such that the dust briquetter 120 may function with the high operational temperatures of the dust. For example, in some cases, heat-sensitive components of the dust briquetter 120, such as the pressing tools of the dust briquetter 120, are cooled with various cooling agents such as water, air, or various other suitable cooling agents. In these cases, during operation, the dust briquetter 120 both compresses the dust and cools the dust through the cooled components to reduce oxygen contact with the various organic components of the dust while lowering the temperature of the dust. In some examples, additional features for functioning with the high operational temperatures of the dust may be provided with the dust briquetter 120, including, but not limited to, having feed points at various locations of the dust briquetter 120 to supply inert gas to reduce re-oxidation of the dust within the dust briquetter 120, using high temperature-resistant materials (such as various steels, among others) to form various components of the dust briquetter 120, using components of the dust briquetter 120 that allow for thermal expansion, having the dust briquetter 120 operate at specific pressing forces, etc.

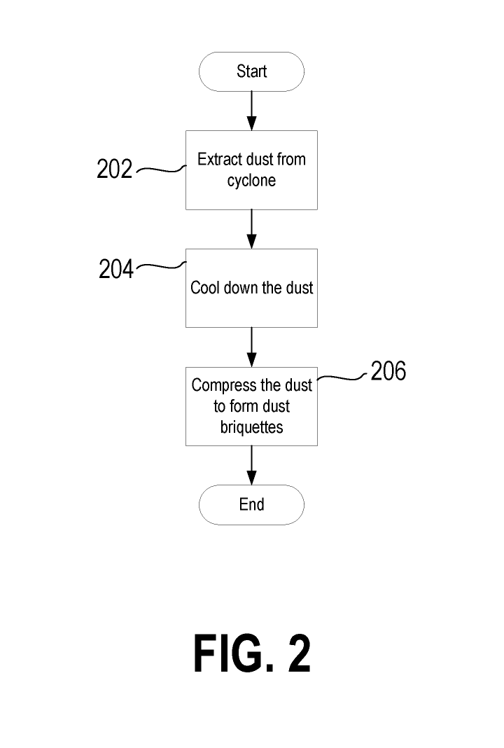

FIG. 2 is a flowchart showing an exemplary method of forming briquettes from the dust from the cyclone 104 using the dust briquetter 120. In block 202, dust is extracted from the cyclone 104. The dust discharged from the cyclone 104 in block 202 is generally at a discharge temperature of from about 250° C. to about 400° C. In various examples where the dust is continuously fed to the dust briquetter 120 (such as through a conveyor), the cyclone 104 may include an interlock or other similar mechanism to control the rate of dust discharge from the cyclone.

In block 204, the dust is cooled down to reduce the temperature of the dust from the discharge temperature to a briquetting temperature, which is less than the discharge temperature. In various cases, the briquetting temperature is from about 20° C. to about 150° C. In one example, the briquetting temperature is approximately 60° C. or higher. Various techniques may be used in block 204 to reduce the temperature of the dust to the briquetting temperature. Cooling of the dust in block 204 may occur prior to delivery of the dust to the dust briquetter 120, within the dust briquetter 120, or a combination of both.

In some cases, a cooled conveyor (such as a water-cooled screw feeder) or other similar mechanism forming the feed path 122 cools the dust as the dust is delivered from the cyclone 104 to the dust briquetter 120. In other examples, the dust is cooled by introducing limited quantities of water to the dust such that heat from the dust flashes off as steam. For example, in some cases, quantities of water from about 5% to about 10% w/w may be used. In some examples, various additives may be added to the water to reduce or prevent the generation of dangerous waste (e.g. hydrogen gas). In various examples, the dust is cooled by the cooled components of the dust briquetter 120, such as water-cooled pressing tools, as the dust is compressed. In some examples, a binding agent is mixed with the dust to reduce the temperature of the dust to the briquetting temperature and/or to improve briquette formation compared to dust briquettes formed without binding agents. In various examples, the binding agent may be mixed with the dust prior to delivery of the dust to the dust briquetter 120 or within the dust briquetter 120. Binding agents may be various materials including, but not limited to, carbon powder, hydrated salts, cellulose, starch, waxes, paraffin, lignosulfonate, sodium bicarbonate (as a solid cooling agent or as a solution in the water), or various other suitable binding agents that reduce the temperature of the dust while improving briquette formation. In some examples, the binding agents are inert materials, although they need not be. For example, in some cases, sodium bicarbonate may be added as a solid cooling agent, and the decomposed sodium bicarbonate may cool the dust. The decomposed sodium bicarbonate further gives off carbon dioxide, which would displace air and further help avoid oxidation. The person having ordinary skill in the art will appreciate that the above cooling techniques may be used independently or in various combinations to reduce the temperature of the dust to the briquetting temperature.

In block 206, the dust is compressed to form dust briquettes. In some examples, the cooling of the dust in block 204 and the compressing of the dust in block 206 occur simultaneously. In other examples, the dust is compressed after the dust has been cooled.

In various optional examples, the system need not be a direct feeding system, and dust may be stored for any desired duration of time at various stages throughout the process (e.g., after block 202, after block 204, etc.). For example, in some cases, the dust may be momentarily or temporarily stored for a predetermined amount of time prior to briquetting. As another non-limiting example, the dust may be momentarily or temporarily stored with or without a mixing step prior to briquetting. Optionally, the dust may be temporarily or momentarily stored in a dust bin, surge hopper, or various other suitable location.

The dust briquettes formed by the dust briquetter 120 provide advantages over uncompressed dust from the cyclone 104. Compared to uncompressed dust, a dust briquette is less porous and denser than a corresponding amount of uncompressed dust. Because the dust briquette is less porous, the rate of air ingress into the dust briquette is reduced (i.e., less air can infiltrate the dust briquette compared to uncompressed dust over the same period of time), which reduces the tendency to combust. Additionally, because the dust briquette is more dense than uncompressed dust, the thermal conductivity of the dust briquette is increased, which means that the tendency for localized heating is reduced. Therefore, compared to uncompressed dust, dust briquettes formed by the dust briquetter 120 have the benefit of being less porous and denser, which reduces the risk of dust fires. From a waste perspective, because the dust briquettes are more compact than uncompressed dust, the volume of the waste is reduced compared to a corresponding amount of uncompressed dust (or more dust may be disposed of compared to a similar volume of uncompressed dust), which reduces disposal and environmental costs. Once the dust is compressed into dust briquettes, aluminum can be recovered from the briquettes in a recycling process rather than being lost as waste. Moreover, the dust briquettes can be sold to third parties that can use/consume dust briquettes rather than simply disposing of the dust as waste.

A collection of exemplary examples, including at least some explicitly enumerated as “ECs” (Example Combinations), providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

EC 1. A decoating system comprising: a dust cyclone configured to: receive an exhaust gas from a decoating kiln; filter organic particulate matter from the exhaust gas as dust; and discharge the dust at a discharge temperature; and a dust briquetter configured to: receive the dust from the dust cyclone; and compress the dust into dust briquettes.

EC 2. The decoating system of any of the preceding or subsequent example combinations, wherein the dust briquetter is further configured to cool the dust from the discharge temperature to a briquetting temperature.

EC 3. The decoating system of any of the preceding or subsequent example combinations, wherein the discharge temperature is from about 250° C. to about 400° C., and wherein the briquetting temperature is from about 20° C. to about 150° C.

EC 4. The decoating system of any of the preceding or subsequent example combinations, wherein the dust briquetter is further configured to cool the dust by mixing a binding agent with the dust.

EC 5. The decoating system of any of the preceding or subsequent example combinations, wherein the binding agent is an inert material.

EC 6. The decoating system of any of the preceding or subsequent example combinations, wherein the binding agent is selected from the group consisting of hydrated salts, cellulose, starch, waxes, paraffin, sodium bicarbonate, and lignosulfonate.

EC 7. The decoating system of any of the preceding or subsequent example combinations, wherein the dust briquetter is further configured to cool the dust by compressing the dust with water-cooled pressing tools.

EC 8. The decoating system of any of the preceding or subsequent example combinations, further comprising a feed path configured to continuously direct dust from the dust cyclone to the dust briquetter.

EC 9. The decoating system of any of the preceding or subsequent example combinations, wherein the feed path is configured to cool the dust during delivery from the dust cyclone to the dust briquetter.

EC 10. A method of forming dust briquettes from dust from a dust cyclone of a decoating system comprising: extracting the dust containing organic particulate matter from the dust cyclone of the decoating system; cooling the dust from a discharge temperature to a briquetting temperature; and compressing the dust with a dust briquetter to form dust briquettes.

EC 11. The method of any of the preceding or subsequent example combinations, wherein cooling the dust and compressing the dust are performed simultaneously by the dust briquetter.

EC 12. The method of any of the preceding or subsequent example combinations, wherein cooling the dust comprises cooling the dust by the dust briquetter.

EC 13. The method of any of the preceding or subsequent example combinations, wherein cooling the dust by the dust briquetter comprises compressing the dust with water-cooled press tools.

EC 14. The method of any of the preceding or subsequent example combinations, wherein the discharge temperature is from about 250° C. to about 400° C., and wherein the briquetting temperature is from about 20° C. to about 150° C.

EC 15. The method of any of the preceding or subsequent example combinations, further comprising delivering the dust to the dust briquetter after cooling the dust from the discharge temperature to the briquetting temperature.

EC 16. The method of any of the preceding or subsequent example combinations, wherein cooling the dust comprises cooling the dust through a cooled feed path from the dust cyclone to the dust briquetter.

EC 17. The method of any of the preceding or subsequent example combinations, wherein cooling the dust comprises introducing water to the dust and flashing off heat as steam.

EC 18. The method of any of the preceding or subsequent example combinations, further comprising supplying an inert gas within the dust briquetter while compressing the dust to reduce re-oxidation of the dust within the dust briquetter.

EC 19. The method of any of the preceding or subsequent example combinations, wherein compressing the dust comprises applying a force of about 1300 kg/cm² to about 2500 kg/cm².

EC 20. The method of any of the preceding or subsequent example combinations, wherein cooling the dust comprises mixing a binding agent with the dust.

EC 21. The method of any of the preceding or subsequent example combinations, wherein the binding agent comprises an inert material.

EC 22. The method of any of the preceding or subsequent example combinations, wherein the binding agent is selected from the group consisting of hydrated salts, cellulose, starch, waxes, paraffin, sodium bicarbonate, and lignosulfonate.

EC 23. The method of any of the preceding or subsequent example combinations, wherein mixing the binding agent comprises mixing the binding agent before delivering the dust to the dust briquetter and compressing the dust.

EC 24. The method of any of the preceding or subsequent example combinations, wherein mixing the binding agent comprises mixing the binding agent with the dust within the dust briquetter.

EC 25. The method of any of the preceding or subsequent example combinations, wherein compressing the dust comprises increasing a density of the dust compared to uncompressed dust.

EC 26. The method of any of the preceding or subsequent example combinations, wherein compressing the dust comprises decreasing a porosity of the dust compared to uncompressed dust.

EC 27. The method of any of the preceding or subsequent example combinations, wherein compressing the dust comprises increasing a thermal conductivity of the dust compared to uncompressed dust.

EC 28. The method of any of the preceding or subsequent example combinations, further comprising temporarily storing the dust after cooling for a predetermined time period before compressing the dust.

The above-described aspects are merely possible examples of implementations, merely set forth for a clear understanding of the principles of the present disclosure. Many variations and modifications can be made to the above-described example(s) without departing substantially from the spirit and principles of the present disclosure. All such modifications and variations are included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

1-9. (canceled)

10. A method of forming dust briquettes from dust from a dust cyclone of a decoating system comprising:
extracting the dust containing organic particulate matter from the dust cyclone of the decoating system;
cooling the dust from a discharge temperature to a briquetting temperature; and
compressing the dust with a dust briquetter to form dust briquettes.

11. The method of claim 10, wherein cooling the dust and compressing the dust are performed simultaneously by the dust briquetter.

12. The method of claim 10, wherein cooling the dust comprises cooling the dust by the dust briquetter.

13. The method of claim 10, further comprising temporarily storing the dust after cooling for a predetermined time period before compressing the dust.

14. The method of claim 10, further comprising delivering the dust to the dust briquetter after cooling the dust from the discharge temperature to the briquetting temperature.

15. The method of claim 10, wherein cooling the dust comprises introducing water to the dust and flashing off heat as steam.

16. The method of claim 10, further comprising supplying an inert gas within the dust briquetter while compressing the dust to reduce re-oxidation of the dust within the dust briquetter.

17. The method of claim 10, wherein cooling the dust comprises mixing a binding agent with the dust, and wherein the binding agent comprises an inert material.

18. The method of claim 17, wherein mixing the binding agent comprises mixing the binding agent before delivering the dust to the dust briquetter and compressing the dust.

19. The method of claim 17, wherein mixing the binding agent comprises mixing the binding agent with the dust within the dust briquetter.

20. The method of claim 10, wherein compressing the dust comprises at least one of increasing a density of the dust compared to uncompressed dust, decreasing a porosity of the dust compared to uncompressed dust, or increasing a thermal conductivity of the dust compared to uncompressed dust.
